(19) United States
(12) Patent Application Publication
(10) Pub. No.: US 2024/0424717 A1
(43) Pub. Date: Dec. 26, 2024

(54) Electrically Heated and Cooled Rollers

(71) Applicant: Matthews International Corporation, Pittsburgh, PA (US)

(72) Inventors: Thomas HACKFORT, Ahaus-Altstätte (DE); Rene WOLTERS, Stadtlohn (DE); Thorsten BÖING, Rhede (DE); Stefan TERBILLE, Vreden (DE); Carsten KLEINGRIES, Vreden (DE)

(21) Appl. No.: 18/706,039

(22) PCT Filed: Nov. 4, 2022
(86) PCT No.: PCT/US2022/048963

§ 371 Date: Apr. 30, 2024

Related U.S. Application Data
(60) Provisional application No. 63/275,845, filed on Nov. 4, 2021.

(51) Int. Cl. B29C 43/52; B29C 43/24; B29C 43/58; G05D 23/19; H01M 4/04; H05B 3/00; H05B 6/14

(52) U.S. Cl. CPC B29C 43/52; B29C 43/24; B29C 43/58; G05D 23/1951; B29C 2043/5816; H01M 4/0435; H05B 3/0095; H05B 6/145; H05B 2203/005

(57) ABSTRACT

Methods and systems for electrically heating and cooling rollers is described. A system may include one or more rollers comprising one or more electrical heating elements and one or more air channels. The one or more electrical heating elements may integrated to a power source and control circuit through an electrical contact on at least one end of the roller. The control circuit may additionally receive input from one or more temperature sensors.

### CROSS-REFERENCE TO RELATED APPLICATIONS

The present application claims priority to and benefit of U.S. Provisional Application No. 63/275,845 filed Nov. 4, 2021, the disclosure of which is hereby incorporated by reference herein in its entirety.

### TECHNICAL FIELD

The present disclosure relates to an integrated roller device. More specifically, the present disclosure relates to a roller capable of maintaining exact dimensions through precise temperature control.

In the field of forming products such as sheets, films, and webs, handling such products, calendering, and the like, there is frequently the need to produce these products precisely, with minimal thickness variation. Meanwhile, the large overall size of some rollers combined with thermal expansion associated with roller materials causes changes in the roller size, which can affect the thickness and other dimensions of the products. Thus, there is a long-standing need to provide a device for regulating the roll nip, wherein a homogenous thickness of a material web passing the roll nip is guaranteed. This means that the roll nip must be kept constant independent of the load and external environment, for example by maintaining a precise, uniform temperature through the entire roll nip.

The exact thickness of film profile is also critical, especially in the field of manufacturing electrochemical cells such as Li-ion cells. The thickness of the film must be uniform over its entire length. This is because during production of Li-ion cells such as cylindrical, prismatic, or pouch cells, the electrode films are fabricated and laminated to other layers such as the separator and current collectors before the entire endless laminated film is cut to a pre-determined length. The cut laminated film is wound to form a Li-ion. Any deviation in the thickness of the film over its length changes the size of the wound layers of film that result from the above process, potentially resulting in a defective wound body that cannot be used to form a cylindrical, prismatic, or pouch cell. For all of the above reasons, there is a need for improved systems, methods, and apparatus to ensure accuracy of the thickness of the films.

Furthermore, when forming electrochemical cells such as Li-ion cells, accurate temperature is critical. The ingredients that form the electrodes of dry electrode Li-ion cells must be processed at the correct temperature and pressure in order to form electrode layers that meet stringent specifications for thickness and uniformity. These specifications must be maintained over the entire width (transverse direction) of a particular roller so that the uniform thickness and properties are imparted to a film. These specifications must also be maintained as the roller rotates in the machine direction, thereby imparting a uniform thickness and properties to the formed film.

There are a variety of conventional structures and techniques for maintaining the temperature of a roller or roll nip. For example, the roller can include internal channels, bores, or passages that are adapted for the circulation of heated fluid, such as oil, through the roller or roll nip. This has drawbacks, such as the need for complex fluid passages to ensure uniform heating, the lowering of temperature of the fluid as it moves through the roller and loses heat energy, and delays associated with changing rollers which are to be used during production. There is a need for improvements in rollers, including nip rollers, and the structures and techniques associated with controlling the temperature of such rollers.

### SUMMARY

There is provided a roller including one or more temperature control elements, wherein the one or more temperature control elements are electrical devices for maintaining a consistent temperature within the roller.

In some embodiments, the techniques described herein relate to a system including a roller including one or more electrical heating elements integrated inside of the roller, one or more contacts electrically interfaced to the one or more electrical heating elements, and one or more air channels; and a control circuit configured to control the one or more electrical heating elements.

In some embodiments, the roller is divided lengthwise into a series of zones.

In some embodiments, each zone includes an electrical heating element with a unique electrical interface to the control circuit.

In some embodiments, the heating properties of the electrical heating element change in each zone.

In some embodiments, the system further includes one or more temperature sensors.

In some embodiments, at least one of the one or more temperatures sensors are external to the roller.

In some embodiments, at least one of the one or more temperatures sensors are integrated internally in the roller.

In some embodiments, the system further includes one or more active components, wherein the one or more active components include at least one of a fan, blower, pump, or compressor, wherein the one or more active components are interfaced to the control circuit, and wherein the one or more active components are configured to move at least one of a gas or liquid through the one or more air channels.

In some embodiments, the electrical heating element is resistive.

In some embodiments, the electrical heating element is inductive.

In some embodiments, the techniques described herein relate to a method of manufacturing a roller including providing a roller; providing at least one electrical heating elements integrated within the roller; providing at least one electrical contact on at least one extremity of the roller; electrically interfacing the at least one electrical heating elements and the at least one electrical contact; and providing at least one air channel inside the roller.

In some embodiments, each of the at least one electrical heating elements has a unique electrical contact.

In some embodiments, the method further includes providing at least one temperature sensor integrated within the roller.

In some embodiments, the method further includes electrically interfacing the at least one temperature sensor and the at least one electrical contact.

In some embodiments, the techniques described herein relate to a method of maintaining temperature control in a roller including determining, by at least one temperature sensor integrated within the roller and in operable communication with a processor, at least one temperature of the roller; comparing, by the processor, the at least one temperature of the roller with a desired temperature; and in response to the at least one temperature of the roller being greater than the desired temperature, activating an external cooling system interfaced to at least one channel in the roller; and, in response to the at least one temperature of the roller being less than the desired temperature, activating an electrical heating element integrated within the roller.

### DRAWINGS

Aspects, features, benefits and advantages of the embodiments described herein will be apparent with regard to the following description, appended claims, and accompanying drawings where:

FIG. 1 illustrates an integrated roller bending device in accordance with an embodiment.

FIG. 2 illustrates a roller with an integrated heating element in accordance with an embodiment.

FIG. 3 illustrates a roller with an integrated heating element in accordance with another embodiment.

FIG. 4 illustrates a roller divided into heating/cooling zones in accordance with an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

This disclosure describes an apparatus for retaining the alignment of integrated nip rollers to ensure the film produced by the nip rollers has uniform thickness. Precise temperature control of each roller eliminates any undesirable change to the nip through thermal expansion.

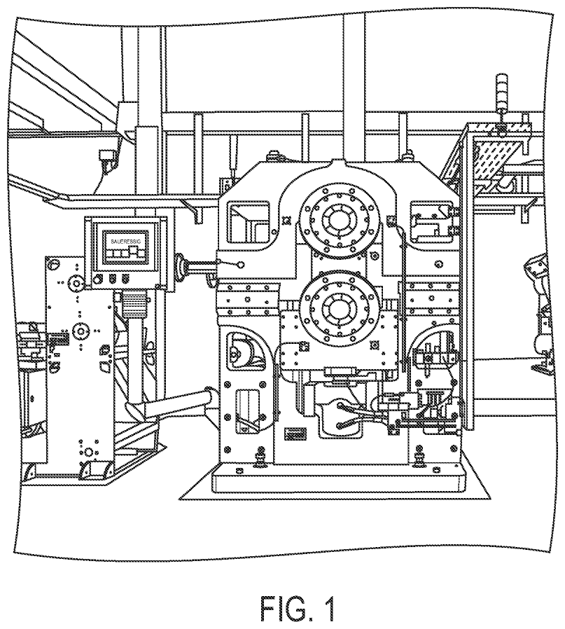

FIG. 1 illustrates an integrated roller bending device in accordance with an embodiment. In some embodiments, the rollers produce a nip accurate to about 1 μm. In this way, it is possible if necessary to configure the rollers with a crown. In some embodiments, the crown ensures that when the roller is deflected or otherwise manipulated, the contact footprint and thus the film profile and film thickness remain flat and accurate. The amount of the crown is not limited and is selected based on the requirements of a particular film and the deflection that is selected for each roller. In some embodiments, the nip roller has a crown of about 3 μm, about 4 μm, about 5 μm, about 6 μm, about 7 μm, about 8 μm, about 9 μm, about 10 μm, or any range of the above values, such as about 3 μm to about 10 μm, about 4 μm to about 9 μm, or about 4 μm to about 8 μm These precise tolerances may be exceeded by thermal expansion in the system if temperature is not controlled.

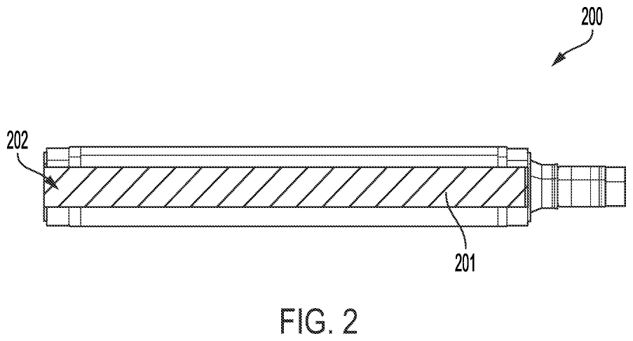

FIG. 2 illustrates a roller 200 with an integrated heating element 201 in accordance with an embodiment. The heating element 201 is configured to maintain a known operating temperature of the roller 200. The known operating temperature allows the roller to perform at a known thermal expansion. In some embodiments, the heating element 201 is resistive. In further embodiments, the heating element 201 is a resistive coil. In alternative embodiments, the heating element 201 is inductive. In still further embodiments, the discrete heating element 201 is omitted and the entire roller is configured so that it is an inductive heating element. A person of ordinary skill in the art will recognize that multiple types of heating elements may be combined to maintain a predetermined temperature within the roller 200. In some embodiments, the heating element 201 is embedded within the roller 200 at a constant depth to uniformly heat the body of the roller 200. In still other embodiments, the heating element 201 is provided on the center axis of the roller 200 or is provided in a cavity that surrounds the center axis of the roller 200.

The configuration of the heating element 201 is not limited, and includes spirals, straight rods, loops that form a central cylinder, zig-zags, or any other physical form that permits the desired temperature profile in the roller.

The heating element 201 is in some embodiments coated by electrical insulation 201 to ensure that the electric current remains within the heating element 201 and is not conducted through the roller 200. The electrical insulation must be electrically resistive but must be thermally conductive. Examples of the electrical insulation include ceramics such as silica, alumina, steatite (magnesium silicate mineral), cordierite (a mineral including iron, magnesium, aluminum, and silicon, but omitting iron in synthetic form), and polymers. When a polymer is employed, it can include a thermally conductive but electrically insulating component, such as alumina or boron nitride. In embodiments where the roller is to have a consistent cyclical bend during operation, the insulation should be a flexible such as a glass fiber or a polymer, or it should be omitted as is possible with inductive heating elements 201.

In certain embodiments, the roller includes a core comprising a different material than the casing of the roller. In further embodiments, the core is hollow and contains a gas, such as air. In some embodiments, the electrical heating element is within said core. In still further embodiments, the core is centered on the central axis of the roller. In some embodiments, the core may comprise one or more openings 202 which allows for the circulation of a gas or fluid for managing the temperature of the roller 200.

In some embodiments, the heating element 201 is electrically interfaced to a power source external to the roller 200. The further embodiments, the interface is an electrical contact on both ends of the roller 200. In alternative embodiments, there is only a single electrical contact on one end of the roller 200.

In certain embodiments, the roller 200 may further comprise one or more air cooling channels. In some embodiments, the channels comprise the core. In other embodiments, the channels are in addition to the core. A portion of the channels may extend the length of the roller 200 with an opening on both ends, extend only a portion of the length of the roller 200 and return to the same end, and/or extend a portion of the length of the roller 200 and terminate. The channels may follow any path through the roller 200, including, but not limited to linear, spiral, curved, or any combination thereof. These channels may be passive or actively cooled with a cooling gas or liquid such as forced air, nitrogen, or other substances, using a system external to the roller 200. In some actively cooled embodiments, the active component of the cooling system is only activated prior to removing the roller 200 during the process of changing rollers. In certain embodiments, the active component is a fan, blower, pump, or compressor. In certain embodiments, the cooling gas circulates during operation so as to provide additional control over the temperature of the roller. The cooling gas can be provided at ambient temperature (for example, about 18° C. to about 24° C., or about 20° C.), higher than ambient temperature, or lower than ambient temperature.

In certain embodiments, the roller 200 may further comprise one or more sensors for measuring temperature. In further embodiments, the temperature sensors may be a resistive temperature sensor. In some embodiments a single temperature sensor may be installed either centrally within the roller 200 or nearer the operating surface of the roller 200. Alternatively, in some embodiments, the temperature sensors are installed externally to the roller 200 and measure the temperature radiating from said roller 200. A person of ordinary skill in the art will recognize that multiple types of temperature sensors may be integrated herein.

In certain embodiments, the heating element 201, active cooling elements, and/or temperature sensors may be integrated to a control circuit external to the roller 200. The control circuit may comprise one or more processors, storage media for storing data and programming instructions/configurations, and communication interfaces.

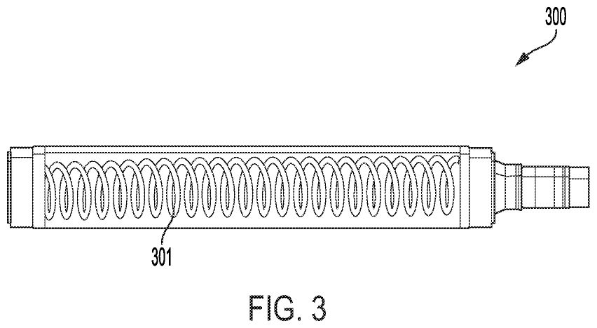

Referring to FIG. 3, a roller 300 with a resistive heating element 301 is depicted in accordance with an embodiment. In this embodiment as depicted, the resistive heating element 301 is configured as a spiral that is inserted within a hollow central core (not shown) of the roller 300. However, it is understood that the exact configuration of the resistive heating element 301 is not particularly limited, and that other shapes that provide the desired temperature profile are also suitable.

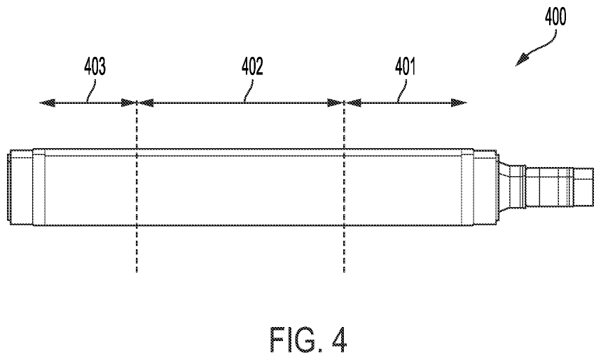

FIG. 4 illustrates a roller divided into heating/cooling zones in accordance with an embodiment. In some embodiments, a roller 400 may vary in thickness or density at different locations across the span of the roller 400. Additionally, or alternatively, in some embodiments, the roller 400 may have non-uniform operational contact across the surface. As a result of said non-uniform operational contact, the surface temperature of the roller 400 may also be non-uniform. To accommodate these scenarios, in some embodiments, the roller 400 may feature multiple zones 401/402/403 of temperature control to ensure that the entire roller is of uniform temperature.

In certain embodiments, each zone 401/402/403 comprises one or more heating elements which do not overlap into other zones. In some embodiments, the individual heating elements are manufactured to produce different temperatures based on a single electrical input. As a result, the individual heating elements may be wired in series within the roller. As a non-limiting example, a resistive element may change in material properties, for example increasing or decreasing in resistance between two zones. Alternatively, each zone 401/402/403 may comprise a separate heating element with unique signal contacts. Each of the depicted zones can have a different heat density depending on the required temperature profile or the profile and performance of the roller. For example, in one embodiment according to the disclosure the amount of heating and thus the number of coils that is provided in a center portion of the roller.

In certain embodiments, each zone may comprise a unique set of one or more temperature sensors. In some embodiments, the temperature sensors in each zone may be internal to the roller 400. In alternative embodiments, the temperature sensors in each zone may be external to the roller 400.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist” of the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A system comprising:
a roller comprising:
one or more electrical heating elements integrated inside of the roller,
one or more contacts electrically interfaced to the one or more electrical heating elements, and
one or more air channels; and
a control circuit configured to control the one or more electrical heating elements.

2. The system of claim 1, wherein the roller is divided lengthwise into a series of zones.

3. The system of claim 2, wherein each zone comprises a respective electrical heating element of the one or more electrical heating elements with a unique electrical interface to the control circuit.

4. The system of claim 3, wherein the heating properties of the respective electrical heating element changes in each zone.

5. The system of claim 1, further comprising one or more temperature sensors.

6. The system of claim 5, wherein at least one of the one or more temperatures sensors are external to the roller.

7. The system of claim 5, wherein at least one of the one or more temperatures sensors are integrated internally in the roller.

8. The system of claim 1, further comprising one or more active components, wherein the one or more active components comprise at least one of a fan, blower, pump, or compressor, wherein the one or more active components are interfaced to the control circuit, and wherein the one or more active components are configured to move at least one of a gas or liquid through the one or more air channels.

9. The system of claim 1, wherein the one or more electrical heating elements are resistive.

10. The system of claim 1, wherein the one or more electrical heating elements are inductive.

11. A method of manufacturing a roller comprising:
providing a roller;
providing at least one electrical heating element integrated within the roller;
providing at least one electrical contact on at least one extremity of the roller;
electrically interfacing the at least one electrical heating element and the at least one electrical contact; and
forming at least one air channel inside the roller.

12. The method of claim 11, wherein each electrical heating element has a unique electrical contact.

13. The method of claim 1, further comprising:
providing at least one temperature sensor integrated within the roller.

14. The method of claim 13, further comprising:
electrically interfacing the at least one temperature sensor and the at least one electrical contact.

15. A method of maintaining temperature control in a roller, the method comprising:
determining, by at least one temperature sensor integrated within the roller and in operable communication with a processor, at least one temperature of the roller;
comparing, by the processor, the at least one temperature of the roller with a desired temperature; and
in response to the at least one temperature of the roller being greater than the desired temperature, activating an external cooling system interfaced to at least one channel in the roller;
in response to the at least one temperature of the roller being less than the desired temperature, activating an electrical heating element integrated within the roller.
